(19) United States
(12) Patent Application Publication
(10) Pub. No.: US 2015/0206194 A1
(43) Pub. Date: Jul. 23, 2015

(54) SETTLEMENT PROCESSING APPARATUS, INFORMATION PROCESSING SYSTEM, AND SETTLEMENT PROCESSING METHOD

(71) Applicant: YAHOO JAPAN CORPORATION, Tokyo (JP)

(72) Inventors: Takafumi KUROHARA, Tokyo (JP); Hiroaki TATETSU, Tokyo (JP)

(21) Appl. No.: 14/487,507

(22) Filed: Sep. 16, 2014

(30) Foreign Application Priority Data
Jan. 20, 2014 (JP) 2014-007688

(51) Int. Cl. G06Q 30/02

(52) U.S. Cl. CPC G06Q 30/0273

(57) ABSTRACT

A settlement processing apparatus according to an embodiment includes a user information storage unit, a first processing unit, a second processing unit, and an advertisement price setting unit. The first processing unit performs a settlement process of setting an amount obtained by deducting a fee of a financial institution from a transaction amount specified by a settlement request as a deposit amount from the financial institution based on identification information of a transaction user. The second processing unit performs a settlement process of setting an amount obtained by deducting a settlement agency fee including a fee of the financial institution from the transaction amount specified by the settlement request as a remittance to the transaction provider. The advertisement price setting unit sets a part or all of the settlement agency fees as an advertisement price of the transaction provider in an advertisement delivery of an advertisement delivery apparatus.

### CROSS-REFERENCE TO RELATED APPLICATIONS

The present application claims priority to and incorporates by reference the entire contents of Japanese Patent Application No. 2014-007688 filed in Japan on Jan. 20, 2014.

### BACKGROUND OF THE INVENTION

1. Field of the Invention

The present invention relates to a settlement processing apparatus, an information processing system, a settlement processing program, and a settlement processing method.

2. Description of the Related Art

In recent years, as the Internet has been rapidly come into wide use, advertisement delivery through the Internet is widespread. For example, there is a known technology in which advertisement content such as a banner advertisement, a text advertisement, and a rich media advertisement is posted on a web page, and in a case where the advertisement content has a link, the site transitions to the web page of a transaction provider (advertiser).

Through the technology, a user who browses the web page can look around the web page of the transaction provider to get more information on products or services which are provided by the transaction provider, or purchase a product or a service which is provided by the transaction provider.

The user inputs his/her identification information (for example, information of a credit card number or an account number of the financial institution) of a financial institution (for example, a credit company or a bank) into the web page to purchase the product or the service on which settlement processing is performed with respect to the transaction provider. For the settlement processing, a contract is needed to be made previously between the transaction provider and the financial institution. As the financial institution to make contract with the transaction provider is increased in number, a paperwork burden of the transaction provider is increased.

Therefore, as a service for lightening the paperwork burden of the transaction provider, a settlement agency service is provided by a settlement agent. The settlement agency service is used by the transaction provider. The settlement agency service is a service provided to help the settlement between the transaction provider and a transaction user, for example, using a settlement processing apparatus (for example, refer to Japanese Patent Application Laid-open No. 2010-044538).

However, the settlement agency service in the related art only offers a settlement service between the transaction provider and the transaction user, but fails to promote the use of an advertisement delivery service.

### SUMMARY OF THE INVENTION

A settlement processing apparatus according to an embodiment includes a user information storage unit, a settlement request reception unit, an acquisition unit, a first processing unit, a second processing unit, and an advertisement price setting unit. The user information storage unit stores information for specifying a transaction user and identification information of the transaction user in a financial institution in association with each other. The settlement request reception unit receives a settlement request containing information for specifying the transaction user, a transaction amount, and a transaction provider. The acquisition unit acquires the identification information of the transaction user specified by the settlement request received by the settlement request reception unit from the user information storage unit. The first processing unit performs a settlement process of setting an amount obtained by deducting a fee of the financial institution from the transaction amount specified by the settlement request as a deposit amount from the financial institution based on the identification information of the transaction user acquired by the acquisition unit. The second processing unit performs a settlement process of setting an amount obtained by deducting a settlement agency fee including a fee of the financial institution from the transaction amount specified by the settlement request as a remittance to the transaction provider. The advertisement price setting unit sets a part or all of the settlement agency fees as an advertisement price of the transaction provider in advertisement delivery of an advertisement delivery apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for describing a settlement processing method according to an embodiment;

FIG. 2 is a diagram illustrating an exemplary configuration of an information processing system according to an embodiment;

FIG. 3 is a diagram illustrating an exemplary configuration of a settlement processing apparatus according to an embodiment;

FIG. 4 is a diagram illustrating an example of a user information table;

FIG. 5 is a diagram illustrating an example of a provider information table;

FIG. 6 is a diagram illustrating an example of a settlement agency fee table;

FIG. 7 is a diagram illustrating an example of a settlement mode table;

FIG. 8 is a diagram illustrating an exemplary configuration of an advertisement delivery apparatus according to an embodiment;

FIG. 9 is a diagram illustrating an example of an advertiser information table;

FIG. 10 is a diagram illustrating an example of a delivery type information table;

FIG. 11 is a diagram illustrating an example of an advertisement information table;

FIG. 12 is a flowchart illustrating an example of information processing in the settlement processing apparatus;

FIG. 13 is a flowchart illustrating an example of settlement processing in the settlement processing apparatus;

FIG. 14 is a flowchart illustrating an example of information processing in the advertisement delivery apparatus; and

FIG. 15 is a diagram illustrating an example of a hardware configuration of a computer which realizes functions of the settlement processing apparatus and the advertisement delivery apparatus.

### DETAILED DESCRIPTION OF THE PREFERRED EMBODIMENTS

Hereinafter, embodiments of a settlement processing apparatus, an information processing system, a settlement processing program, and a settlement processing method according to the present application will be described in detail with reference to the accompanying drawings. In addition, the settlement processing apparatus, the information processing system, the settlement processing program, and the settlement processing method according to the present application are not limited to the embodiments.

1. Settlement Processing Method

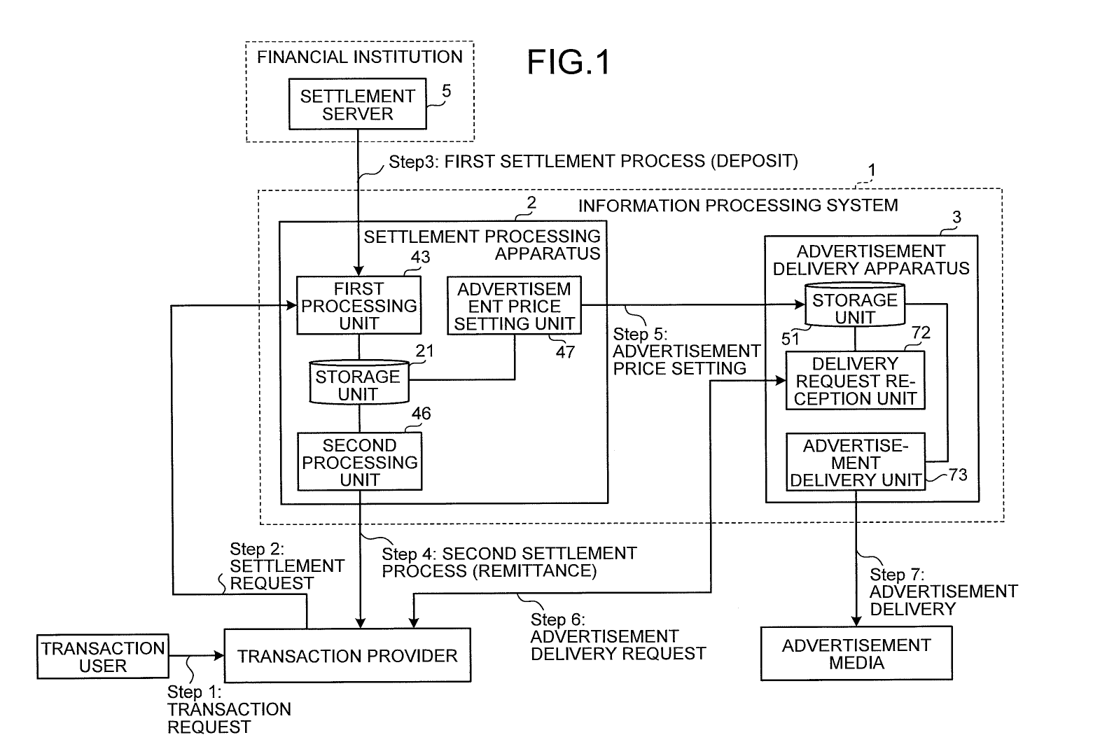

FIG. 1 is a diagram for describing a settlement processing method according to the embodiment, and the settlement processing method is implemented by a settlement processing apparatus of an information processing system in the embodiment.

As illustrated in FIG. 1, an information processing system 1 includes a settlement processing apparatus 2 and an advertisement delivery apparatus 3. The settlement processing apparatus 2 and the advertisement delivery apparatus 3 are managed and operated by the same provider or individual providers. In the following, it is assumed that the same provider (hereinafter, referred to as a settlement agent) manages and operates the settlement processing apparatus 2 and the advertisement delivery apparatus 3.

The settlement processing apparatus 2 offers a service for settlement processing between a transaction user and a transaction provider. Specifically, the settlement processing apparatus 2 pays a predetermined handling fee from a financial institution designated by the transaction user to deposit a transaction amount from the financial institution, and deducts the settlement agency fee including the handling fee of the financial institution from the transaction amount and pays the deducted money to a bank account of the transaction provider.

Further, the advertisement delivery apparatus 3 delivers advertisement information to an advertising medium according to an advertisement delivery request from an advertiser. Specifically, when receiving the advertisement delivery request from the advertiser, the advertisement delivery apparatus 3 delivers the advertisement information designated by the advertisement delivery request to the advertising medium, based on information designated by the advertisement delivery request such as the number of delivery times and a delivery period. Examples of the advertising medium include a web site, an e-mail, a digital signage, a predetermined application used on a user's terminal (for example, a customer oriented application of a distribution company or a moving image browsing application), and the like.

Hereinafter, the settlement processing method according to the embodiment will be described with reference to FIG. 1. As illustrated in FIG. 1, the transaction user makes a transaction request to the transaction provider (Step 1). For example, the transaction user operates a terminal apparatus (hereinafter, referred to as a transaction user apparatus) to access an electronic commerce (EC) site of the transaction provider. Therefore, a purchase page of a product or a service (hereinafter, also referred to as a transaction target) provided by the transaction provider is provided from the EC site to the transaction user apparatus, and displayed in a display of the transaction user apparatus. The transaction user operates the transaction user apparatus to purchase the transaction target in the purchase page, and the transaction request is transmitted from the transaction user apparatus to an apparatus (hereinafter, referred to as the transaction provider apparatus) providing the EC site.

The transaction provider apparatus to which the transaction request is received makes a request for settlement to the settlement processing apparatus 2 (Step 2). The settlement request, for example, includes information for specifying each of the transaction users, the transaction amount of the transaction target, and the transaction provider.

When receiving the settlement request from the transaction provider, the settlement processing apparatus 2 performs a settlement process (hereinafter, also referred to as a first settlement process) of setting an amount obtained by deducting the handling fee of the financial institution from the transaction amount specified by the settlement request as a deposit amount with respect to a settlement server 5 (Step 3).

In the first settlement process, the settlement agent acquires cash corresponding to an amount (hereinafter, also referred to as a first amount) obtained by deducting the handling fee of the financial institution from the transaction amount of the transaction target. For example, in a case where the transaction amount of the transaction target is 100,000 yen and the handling fee of the financial institution is 2.5%, the settlement agent acquires 97,500 yen (=100,000 yen−2,500 yen).

The settlement processing apparatus 2, for example, includes a storage unit 21, a first processing unit 43, a second processing unit 46, and an advertisement price setting unit 47. In the storage unit 21, for example, information for specifying the transaction user and identification information of the transaction user in the financial institution are stored in association with each other.

The identification information of the transaction user, for example, is information of a credit card of the transaction user (for example, information such as a nominal person, a card number, and an expiration date), information of the bank account of the transaction user (for example, information such as the nominal person and an account number), and the like. The settlement processing apparatus 2 acquires the identification information of the transaction user, specified by the settlement request of the transaction provider apparatus, from the storage unit 21.

The first processing unit 43 performs the first settlement process with respect to the settlement server 5 based on the identification information of the transaction user specified by the settlement request of the transaction provider apparatus. In the first settlement process, a process for withdrawing the first amount of cash from the financial institution and a process for depositing the first amount of cash into the bank account of the settlement agent.

When the first settlement process is completed, the second processing unit 46 performs a settlement process (hereinafter, also referred to as a second settlement process) of setting an amount (hereinafter, also referred to as a second amount) obtained by deducting the settlement agency fee according to the settlement mode from the transaction amount specified by the settlement request as a remittance to the transaction provider (Step 4). Herein, the “remitting”, for example, is to send cash through a bank transfer, registered mail, a post money order, and the like.

Through the second settlement process, the cash corresponding to the second amount is deposited into the bank account of the transaction provider, and the settlement agent acquires an amount of cash obtained by deducting the handling fee of the financial institution from the settlement service fee. For example, in a case where the transaction amount of the transaction target is 100,000 yen, the handling fee of the financial institution is 2.5%, and the settlement agency fee is 3.5%, the settlement agent acquires 1,000 yen (=3,500 yen−2,500 yen).

In the storage unit 21, for example, information for specifying the transaction provider, information of a settlement mode, the identification information of the transaction provider in the financial institution are stored in association with each other. The identification information of the transaction provider, for example, is information of the bank account of the transaction provider. The settlement processing apparatus 2 acquires the identification information of the transaction provider and the information of the settlement mode, which are associated with the information of the transaction provider specified by the settlement request, from the storage unit 21.

In a case where the information of the settlement mode acquired from the storage unit 21 is information of a first settlement mode, the second processing unit 46 of the settlement processing apparatus 2 sets the settlement agency fee to a first fee. On the other hand, in a case where the information of the settlement mode acquired from the storage unit 21 is information of a second settlement mode, the second processing unit 46 sets the settlement agency fee as a second fee which is higher than the first fee. For example, the first fee is 3.5%, and the second fee is 5%.

The second processing unit 46, for example, makes a request for a transfer process on the bank account of the transaction provider, which is specified by the settlement request from the transaction provider apparatus, from the settlement server 5 of the financial institution to perform a settlement process on an amount obtained by deducting the settlement agency fee from the transaction amount.

When the second settlement process is completed, the advertisement price setting unit 47 sets the settlement agency fee set to a second settlement mode as the advertisement price of the transaction provider (Step 5). Specifically, in a case where the information of the settlement mode of the transaction provider specified by the settlement request from the transaction provider apparatus is the information of the second settlement mode, the advertisement price setting unit 47 stores the settlement agency fee as the advertisement price of the transaction provider in the storage unit 21. Further, the advertisement price setting unit 47 informs the advertisement delivery apparatus 3 about the information of the advertisement price of the transaction provider stored in the storage unit 21. The advertisement price is a price for posting in the advertising medium.

The advertisement delivery apparatus 3 stores the information of the advertisement price informed from the settlement processing apparatus 2 as an accumulated fee for each transaction provider, and the accumulated fee is appropriated at a cost (the advertisement price) of the advertisement delivery. Therefore, since the transaction provider can use the settlement agency fee paid in the first settlement mode as the advertisement price, the settlement agency service performed by the settlement agent can be promoted, and furthermore the advertisement delivery can be promoted.

Specifically, the advertisement delivery apparatus 3 includes a storage unit 51, a delivery request reception unit 72, and an advertisement delivery unit 73. The delivery request reception unit 72 receives the advertisement delivery request from the transaction provider (Step 6). In the advertisement delivery request includes advertisement information of the transaction provider, information of an advertisement delivery condition, and information on whether the accumulated fee is available.

The advertisement delivery unit 73 delivers the advertisement information included in the advertisement delivery request to the advertising medium (Step 7). In a case where the information indicating that the accumulated fee is available is contained in the advertisement delivery request, the advertisement delivery unit 73 deducts a cost of the advertisement delivery corresponding to the advertisement delivery request from the accumulated fee of the transaction provider who makes the advertisement delivery request. In addition, some of the cost of the advertisement delivery may be appropriated from the accumulated fee.

Therefore, the information processing system 1 according to the embodiment can use the settlement agency fee as the advertisement price, and thus the use of the advertisement delivery service can be promoted.

2. Information Processing System 1

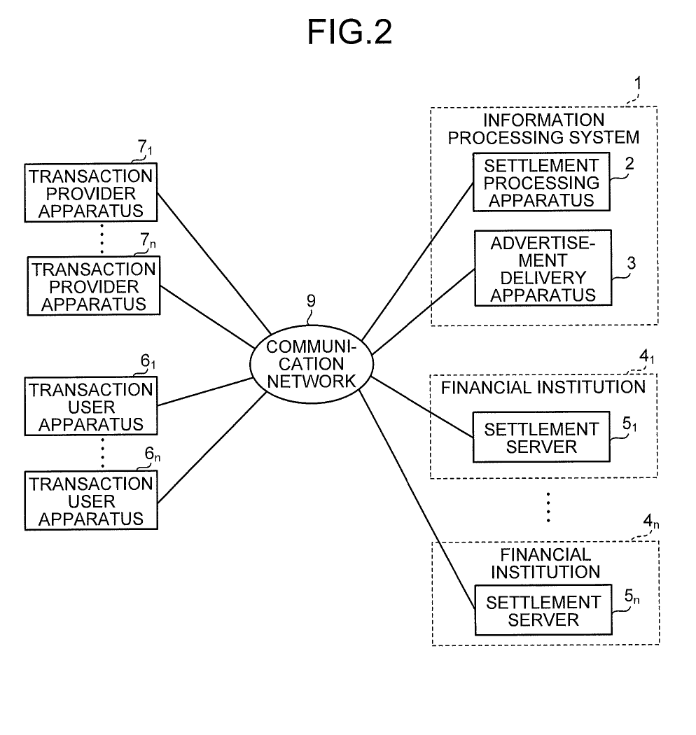

An exemplary configuration of the information processing system 1 according to the embodiment will be described with reference to FIG. 2. FIG. 2 is a diagram illustrating an exemplary configuration of the information processing system 1 according to the embodiment.

As illustrated in FIG. 2, the information processing system 1 includes the settlement processing apparatus 2 and the advertisement delivery apparatus 3. The settlement processing apparatus 2 and the advertisement delivery apparatus 3 are connected to a communication network 9. Further, a plurality of settlement servers 5₁ to 5ₙ, a plurality of transaction user apparatuses 6₁ to 6ₙ, and a plurality of transaction provider apparatuses 7₁ to 7ₙ are connected to the communication network 9.

The settlement processing apparatus 2, the advertisement delivery apparatus 3, the settlement servers 5₁ to 5ₙ, the transaction user apparatuses 6₁ to 6ₙ, and the transaction provider apparatuses 7₁ to 7ₙ can make communication to each other through the communication network 9. The communication network 9, for example, is a wide area network (WAN) such as the Internet. Hereinafter, the plurality of settlement servers 5₁ to 5ₙ will be collectively referred to as a settlement server 5, the transaction user apparatuses 6₁ to 6ₙ will be collectively referred to as a transaction user apparatus 6, and the transaction provider apparatuses 7₁ to 7ₙ will be collectively referred to as a transaction provider apparatus 7.

The settlement servers 5₁ to 5ₙ are respectively provided in the financial institutions 4₁ to 4ₙ, and can perform various settlement processes with respect to the settlement processing apparatus 2. In addition, the settlement server 5 may be provided not in each of the financial institutions 4₁ to 4ₙ as long as the settlement process can be performed based on the information transmitted from the settlement processing apparatus 2.

The transaction user apparatus 6 is a terminal apparatus which has a communication function and a browser function such as a personal computer (PC), a tablet PC, and a smart phone.

Each of the transaction provider apparatuses 7₁ to 7ₙ is provided for each of a plurality of transaction providers, and provides the EC site. The EC site, for example, provides a web page which displays a list of the transaction targets, a web page (hereinafter, referred to as a transaction target purchase page) which is used for the transaction user to purchase the transaction target, and the like to the transaction provider apparatus 7. The transaction user apparatus 6 can access the transaction provider apparatus 7 to acquire various web pages which are provided by the EC site, and display the web pages in a display unit (not illustrated).

Hereinafter, the configurations of the settlement processing apparatus 2 and the advertisement delivery apparatus 3 will be specifically described.

3. Settlement processing apparatus 2

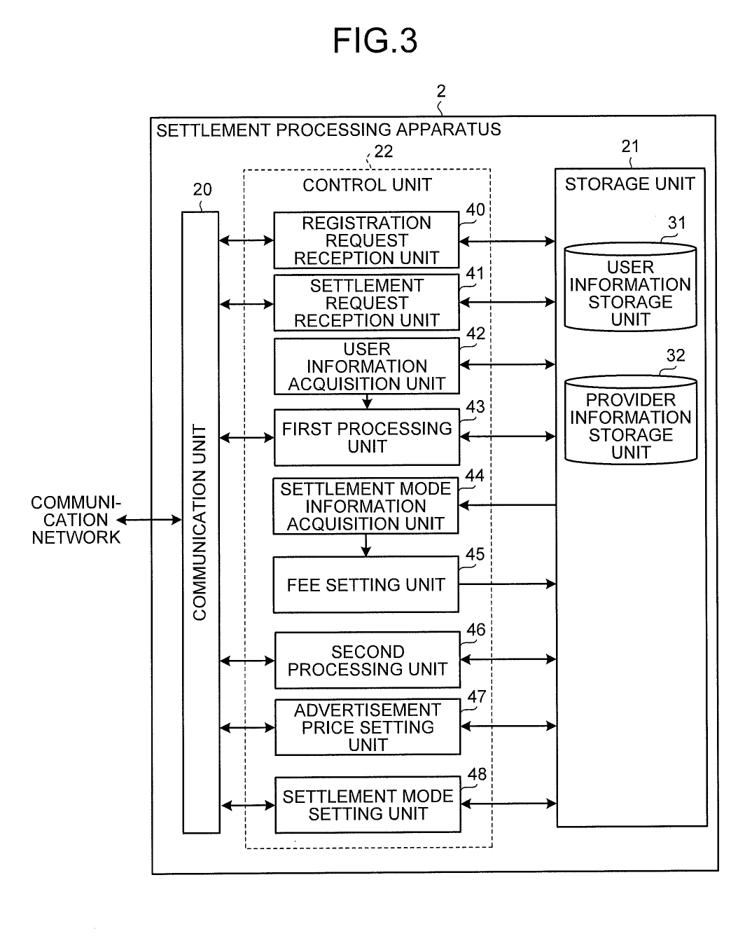

FIG. 3 is a diagram illustrating an exemplary configuration of the settlement processing apparatus 2 according to an embodiment. As illustrated in FIG. 3, the settlement processing apparatus 2 includes a communication unit 20, the storage unit 21, and a control unit 22.

The communication unit 20 is a communication interface to make communication between the apparatuses connected to the communication network 9 and the control unit 22. For example, the communication is performed through a protocol such as TCP/IP or UDP. The control unit 22 makes communication with the apparatuses connected to the communication network 9 through the communication unit 20.

The control unit 22, for example, is realized by an integrated circuit such as an application specific integrated circuit (ASIC) or a field programmable gate array (FPGA). Further, for example, a program stored in the storage unit 21 is executed by a central processing unit (CPU) or a micro processing unit (MPU) using internal RAM (not illustrated) as a work area, and thus the control unit 22 realizes or executes the following function and operation to process information.

Specifically, the control unit 22 executes a retrieval processing program stored in the storage unit 21 to perform functions as a registration request reception unit 40, a settlement request reception unit 41, a user information acquisition unit 42, the first processing unit 43, a settlement mode information acquisition unit 44, a fee setting unit 45, the second processing unit 46, the advertisement price setting unit 47, and a settlement mode setting unit 48. In addition, the configuration of the control unit 22 is not limited the above configuration, and other configurations may be allowed as long as the information process described below is performed.

Further, the storage unit 21 includes a user information storage unit 31 and a provider information storage unit 32. Hereinafter, the registration request reception unit 40, the settlement request reception unit 41, the user information acquisition unit 42, the first processing unit 43, the settlement mode information acquisition unit 44, the fee setting unit 45, the second processing unit 46, the advertisement price setting unit 47, and the settlement mode setting unit 48 will be specifically described while describing the user information storage unit 31 and the provider information storage unit 32.

3.1. Registration Request Reception Unit 40

The registration request reception unit 40 receives a user information registering request transmitted from the transaction user apparatus 6 and a provider information registration request transmitted from the transaction provider apparatus 7.

The user information registering request transmitted from the transaction user apparatus 6 contains information for specifying the transaction user, identification information of the transaction user in the financial institution, and the like. When receiving the user information registering request from the transaction user apparatus 6, the registration request reception unit 40 sets the information contained in the user information registering request to a user information table of the user information storage unit 31.

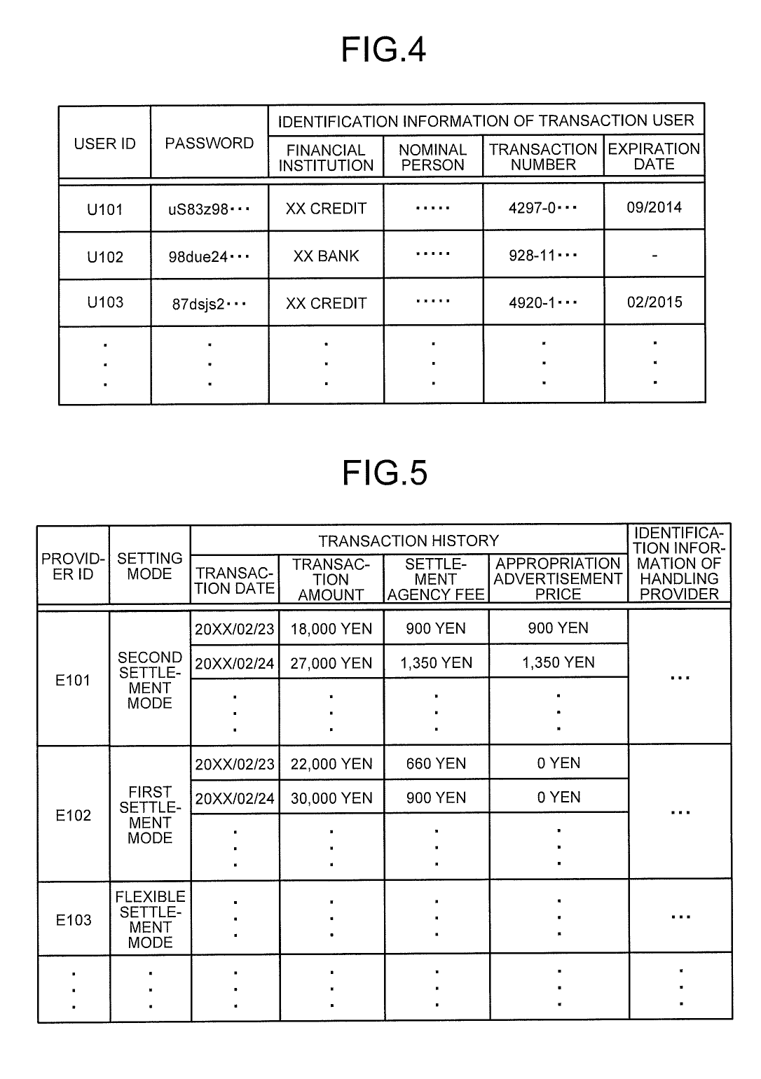

FIG. 4 is a diagram illustrating an example of the user information table stored in the user information storage unit 31. As illustrated in FIG. 4, the user information table includes information associated with “password” and “identification information of the transaction user” for each “user ID”.

The “user ID” is the identification information which is allocated to each transaction user by the registration request reception unit 40. The “password”, for example, is a character string containing English letters and numbers, and is set by the transaction user or the registration request reception unit 40.

The “identification information of the transaction user” is identification information of the transaction user in the financial institution, and contains information such as “financial institution”, “nominal person”, “transaction number”, and “expiration date” in the example illustrated in FIG. 4.

The “financial institution” is information for specifying a financial institution which is used by the user, and contains information of a credit company and information of a bank for example. For example, in a case where the financial institution is the credit company, the “nominal person” is information indicating the name of the credit card holder. In a case where the financial institution is the bank, the “nominal person” is information indicating the name of the bank account holder.

The “transaction number” is information for specifying the transaction number of the user in the financial institution. For example, in a case where the financial institution is the credit company, the “transaction number” is information indicating a credit card number. In a case where the financial institution is the bank, the “transaction number” is information indicating the account number of the bank account.

The “expiration date” is information indicating an expiration date of the identification information of the transaction user. For example, in a case where the financial institution is the credit company, the “expiration date” is information indicating the expiration date of the credit card.

Further, when receiving the provider information registration request from the transaction user apparatus 6, the registration request reception unit 40 sets information contained in the provider information registration request in a provider information table of the provider information storage unit 32. In the provider information registration request, for example, information of a setting mode and identification information of a handling provider are contained.

FIG. 5 is a diagram illustrating an example of the provider information table stored in the provider information storage unit 32. As illustrated in FIG. 5, the provider information table includes information associated with “setting mode”, “transaction history”, and “identification information of the handling provider” for each “provider ID”. The “provider ID” is identification information which is allocated to each transaction provider by the registration request reception unit 40.

The “setting mode” is set based on the information of the setting mode contained in a setting registration information request from the transaction provider. In the “setting mode”, any one of the first settlement mode, the second settlement mode, and a flexible settlement mode is set.

The first settlement mode is a mode in which the settlement agency fee is not appropriated for the advertisement price, and the second settlement mode is a mode in which the settlement agency fee is appropriated for the advertisement price. The flexible settlement mode is a mode in which any one of the first settlement mode and the second settlement mode is set based on a transaction state of the transaction provider.

The information of the “transaction history” is information indicating a history of transactions between the transaction provider and the transaction user. In the example illustrated in FIG. 5, the information of the “transaction history” contains “transaction date”, “transaction amount”, “settlement agency fee”, and “appropriation advertisement price”.

The “transaction date” indicates a date when the transaction of a transaction target is concluded between the transaction provider and the transaction user. For example, the “transaction date” indicates a date when the settlement process on the transaction target is completed. The “transaction amount” indicates an amount of the transaction target on which the transaction is concluded. The “settlement agency fee” indicates a fee of the settlement agent for the concluded transaction. The “appropriation advertisement price” indicates an amount of the settlement agency fee which is appropriated at a cost of the advertisement delivery in the advertisement delivery apparatus 3.

The “identification information of the handling provider” is set on the basis of the identification information of the handling provider which is contained in the setting registration information request from the transaction provider. The “identification information of the transaction provider” is identification information of the transaction provider in the financial institution. Similarly to the “identification information of the transaction user” illustrated in FIG. 4, for example, the “identification information of the transaction provider” contains information such as the “financial institution”, the “nominal person”, and the “transaction number”.

3.2. Settlement Request Reception Unit 41

The settlement request reception unit 41 receives the settlement request transmitted from the transaction user apparatus 6 or the transaction provider apparatus 7. The settlement request contains information for specifying the transaction user, the transaction amount, and the transaction provider. For example, the information for specifying the transaction user is the user ID, and the information for specifying the transaction provider is the provider ID.

For example, when the transaction user apparatus 6 makes a purchase request to the EC site provided by the transaction provider apparatus 7, the settlement request is transmitted from the transaction provider apparatus 7 to the settlement processing apparatus 2. Further, for example, the settlement request may be transmitted from the transaction user apparatus 6 to the settlement processing apparatus 2 based on the information provided from the EC site provided by the transaction provider apparatus 7 to the transaction user apparatus 6.

3.3. User Information Acquisition Unit 42

The user information acquisition unit 42 acquires the identification information of the transaction user which is specified by the settlement request received by the settlement request reception unit 41 from a user information table stored in the storage unit 21.

For example, in a case where the user information table is in a state illustrated in FIG. 4 and the user ID of the transaction user contained in the settlement request is “U101”, the user information acquisition unit 42 acquires the identification information of the transaction user associated with “U101” in the user information table.

3.4. First Processing Unit 43

The first processing unit 43 performs a settlement process based on the identification information of the transaction user acquired by the user information acquisition unit 42, in which an amount (hereinafter, referred to as a first settlement amount) obtained by deducting a predetermined handling fee from the transaction amount specified by the settlement request is set as a deposit amount from the financial institution.

For example, in a case where the identification information of the transaction user is the information of the credit card, the first processing unit 43 transmits the information of the credit card, the information of the transaction amount, and the identification information of the settlement agent to the settlement server 5 of the credit company. The settlement server 5, for example, prepares a process for withdrawing the cash corresponding to the transaction amount from the bank account of the transaction user associated with the credit card, and a process for depositing the cash corresponding to the first settlement amount into the bank account of the settlement agent. In addition, for example, these preparations are made by depositing the cash corresponding to the first settlement amount into the bank account of the settlement agent every month.

Further, in a case where the identification information of the transaction user is the information of the bank account, the first processing unit 43 performs the settlement process of the transaction amount by transmitting information of the bank account designated by the transaction user, information of the transaction amount, and account information of the settlement agent to the settlement server 5 of the bank. The settlement server 5, for example, performs a process for withdrawing the cash corresponding to the transaction amount from the bank account designated by the transaction user, and a process for depositing the cash corresponding to the first settlement amount into the bank account of the settlement agent.

Through these processes, the settlement agent acquires the cash corresponding to the first settlement amount. In a case where the transaction amount of the transaction target is 100,000 yen and the handling fee of the financial institution is 2.5%, the settlement agent acquires 97,500 yen (=100,000 yen−2,500 yen).

3.5. Settlement Mode Information Acquisition Unit 44

The settlement mode information acquisition unit 44 acquires the settlement mode information associated with the information of the transaction provider specified by the settlement request from the provider information table of the provider information storage unit 32 (see FIG. 5).

For example, the provider information table is assumed to be in the state illustrated in FIG. 5. In this case, when the provider ID of the transaction provider specified by the settlement request is “E101”, the settlement mode information acquisition unit 44 acquires the information of the second settlement mode from the provider information table. Further, when the provider ID of the transaction provider specified by the settlement request is “E102”, the settlement mode information acquisition unit 44 acquires the information of the first settlement mode from the provider information table.

Further, when the provider ID of the transaction provider specified by the settlement request is “E103”, the settlement mode information acquisition unit 44 acquires the information of the settlement mode determined by the settlement mode setting unit 48. In addition, the settlement mode setting unit 48 can set the information of the determined settlement mode in the provider information table. In this case, the settlement mode information acquisition unit 44 can acquire the information of the settlement mode from the provider information table.

3.6. Fee Setting Unit 45

The fee setting unit 45 sets the settlement agency fee according to the information of the settlement mode acquired by the settlement mode information acquisition unit 44. Specifically, the fee setting unit 45 determines the settlement agency fee to be deducted from the transaction amount specified by the settlement request based on a settlement agency fee table.

For example, in a case where the information of the settlement mode acquired by the settlement mode information acquisition unit 44 is the information of the first settlement mode, the fee setting unit 45 sets the settlement agency fee to the first fee. Further, in a case where the information of the settlement mode acquired by the settlement mode information acquisition unit 44 is the information of the second settlement mode, the fee setting unit 45 sets the settlement agency fee to the second fee which is higher than the first fee. Further, in a case where the information of the settlement mode acquired by the settlement mode information acquisition unit 44 is the flexible settlement mode, the fee setting unit 45 sets a fee according to the settlement mode determined by the settlement mode setting unit 48 as the settlement agency fee.

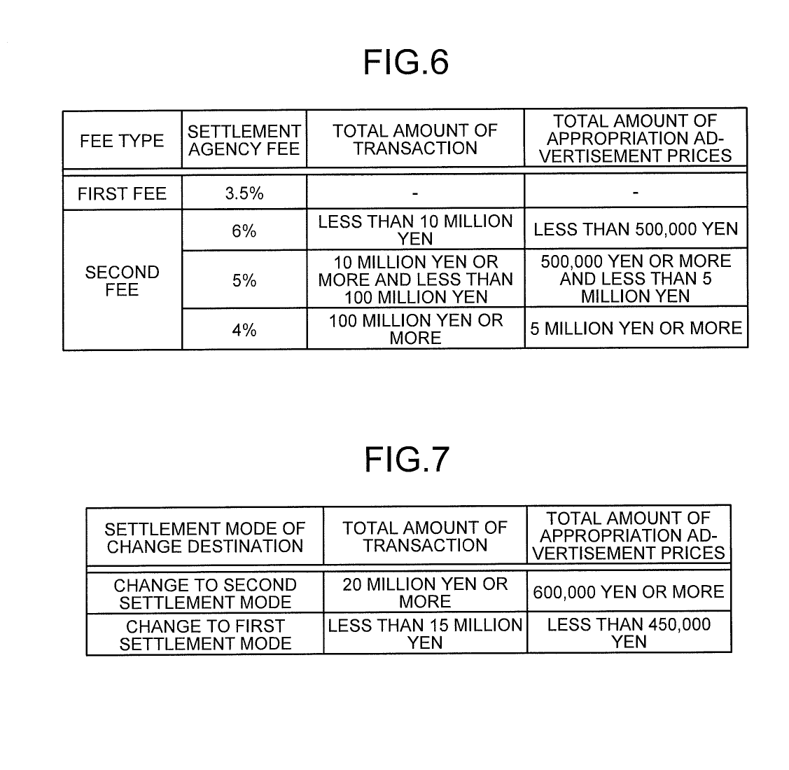

The setting of the settlement agency fee by the fee setting unit 45 is performed based on the settlement agency fee table. FIG. 6 is a diagram illustrating an example of the settlement agency fee table stored in the provider information storage unit 32. As illustrated in FIG. 6, the settlement agency fee table is information associated with “fee type”, “settlement agency fee”, “total amount of transaction”, and “total amount of appropriation advertisement prices”.

The “fee type” indicates the type of the settlement agency fee according to the settlement mode. The type of the settlement agency fee includes the first fee and the second fee.

The “settlement agency fee” is information for specifying the settlement agency fee to be deducted from the transaction amount, and in the example illustrated in FIG. 6, a ratio of the settlement agency fee to the transaction amount is set. For example, in a case where the “settlement agency fee” is 6% and the transaction amount is 10,000 yen, the settlement agency fee to be deducted from the transaction amount specified by the settlement request is 600 yen.

In the example, the settlement agency fee illustrated in FIG. 6 is constant regardless of the transaction amount, but the ratio to the transaction amount may be changed according to the transaction amount. Further, the settlement agency fee is not limited to the ratio to the transaction amount, and may be set to an amount according to a range of the transaction amount and may be set by combination with the amount according to the range of the transaction amount or a ratio to the transaction amount.

The “total amount of transaction” indicates a total sum of transaction amounts of the transaction provider, which are settled in the settlement processing apparatus 2, for example, in a predetermined period of time (for example, a weekly or monthly period). In the example illustrated in FIG. 6, for example, the fee setting unit 45 applies a settlement agency fee of 6% to the transaction provider whose total amount of transaction is less than 10 million yen, applies a settlement agency fee of 5% to the transaction provider whose total amount of transaction is equal to or more than 10 million yen and less than 100 million yen, and applies a settlement agency fee of 4% to the transaction provider whose total amount of transaction is equal to or more than 100 million yen.

The “total amount of appropriation advertisement prices”, for example, indicates a total sum of appropriation advertisement prices set for each transaction provider by the advertisement price setting unit 47 in a predetermined period of time (for example, a weekly or monthly period). In the example illustrated in FIG. 6, for example, the fee setting unit 45 applies a settlement agency fee of 6% to the transaction provider whose total amount of appropriation advertisement prices is less than 500,000 yen, applies a settlement agency fee of 5% to the transaction provider whose total amount of appropriation advertisement prices is equal to or more than 500,000 yen and less than 5 million yen, and applies a settlement agency fee of 4% to the transaction provider whose total amount of appropriation advertisement prices is equal to or more than 5 million yen.

In a case where the settlement agency fee corresponding to the total amount of transaction is different from the settlement agency fee corresponding to the total amount of appropriation advertisement prices, the fee setting unit 45 determines the lowest settlement agency fee among these settlement agency fees as the settlement agency fee of the transaction provider. The fee setting unit 45 may determine the settlement agency fee of the transaction provider with reference to one of the total amount of transaction and the total amount of appropriation advertisement prices, for example, based on a selection of the transaction provider or a setting of the settlement agency provider.

The fee setting unit 45 can calculate the total amount of transaction and the total amount of appropriation advertisement prices based on the information of the transaction history of the provider information table stored in the provider information storage unit 32. For example, it is assumed that the provider information table shows the states illustrated in FIG. 5 and the provider ID of the transaction provider who is a subject of the settlement agency fee is “E101”.

In this case, the fee setting unit 45 extracts the transaction amounts in a predetermined period of time (for example, a weekly or monthly period) and the information of the appropriation advertisement price from the information of the transaction history of which the provider ID is “E101”, and calculates the transaction amounts in the predetermined period of time and a total sum of the appropriation advertisement prices.

In addition, the fee setting unit 45 may calculate a total sum of the transaction amounts and a total sum of the appropriation advertisement prices as the “total amount of transaction” and the “total amount of appropriation advertisement prices” in the last predetermined period of time (for example, a period from a week earlier up to the current time or a period from a month earlier up to the current time). In addition, the predetermined period of time can be set based on a selection of the transaction provider or a setting of the settlement agency provider.

Herein, it is assumed that the settlement agency fee table shows the states illustrated in FIG. 6 and the total amount of transaction of the transaction provider specified by the settlement request is 20 million yen. In this case, when the settlement mode of the transaction provider specified by the settlement request is the first settlement mode, the fee setting unit 45 determines “3.5%” as the settlement agency fee. Further, when the settlement mode of the transaction provider specified by the settlement request is the second settlement mode, the fee setting unit 45 determines “5%” as the settlement agency fee.

Further, in the second settlement mode, in a case where the advertisement price set by the advertisement price setting unit 47 is not used as a cost of the advertisement delivery of the advertisement delivery apparatus 3 for a predetermined period of time, the fee setting unit 45 may increase the settlement agency fee. Further, in a case where a total sum of the advertisement prices which are not used for the predetermined period of time while being set by the advertisement price setting unit 47 is equal to or more than a predetermined amount, the fee setting unit 45 may increase the settlement agency fee.

3.7. Second Processing Unit 46

The second processing unit 46 transmits a settlement request to the settlement server 5 of the financial institution designated by the transaction provider in order to set an amount (hereinafter, referred to as a second settlement amount) obtained by deducting the settlement agency fee set by the fee setting unit 45 from the transaction amount specified by the settlement request as the remittance to the transaction provider.

Specifically, the second processing unit 46 acquires the identification information of the transaction provider specified by the settlement request from the provider information table stored in the provider information storage unit 32. In a case where the identification information of the transaction provider is the information of the bank account, the second processing unit 46 performs the settlement process by transmitting the settlement request containing the information of the bank account designated by the transaction provider, the information of the transaction amount, and the account information of the settlement agent to the settlement server 5 of the bank.

The settlement server 5, for example, performs a process for withdrawing the cash corresponding to the second settlement amount from the account of the settlement agent, and a process for depositing the cash corresponding to the second settlement amount into the back account of the transaction provider.

When the settlement process is completed with respect to the settlement server 5, the second processing unit 46 sets the information of the settlement history as the transaction history in the provider information table which is stored in the provider information storage unit 32. The information of the transaction history set in the provider information table, for example, is information of the transaction date, the transaction amount, the settlement agency fee, and the appropriation advertisement price.

Through the settlement process by the second processing unit 46, the settlement agent acquires the settlement agency fee, and acquires the cash amount obtained by deducting the handling fee of the financial institution from the settlement agency fee. For example, in a case where the transaction amount of the transaction target is 100,000 yen, the handling fee of the financial institution is 2.5%, and the settlement agency fee is 5%, the settlement agent acquires 2,500 yen (=5,000 yen−2,500 yen).

3.8. Advertisement price Setting Unit 47

In a case where the setting mode of the transaction provider specified by the settlement request is set to the second settlement mode, the advertisement price setting unit 47 sets the settlement agency fee acquired in the second processing unit 46 as the advertisement price of the transaction provider in the advertisement delivery of the advertisement delivery apparatus 3.

In the following, the description will be made on the assumption that the advertisement price setting unit 47 sets the total settlement agency fee acquired in the second processing unit 46 as the advertisement price of the transaction provider, but some of the settlement agency fee may be set as the advertisement price of the transaction provider.

In a case where the settlement agency fee set by the second processing unit 46 is the second fee, the advertisement price setting unit 47 transmits an advertisement price setting request to the advertisement delivery apparatus 3. The advertisement price setting request, for example, contains information of the advertisement price set by the advertisement price setting unit 47, information of the transaction amount specified by the settlement request, and information of the transaction provider specified by the settlement request.

3.9. Settlement Mode Setting Unit 48

The settlement mode setting unit 48 determines a settlement mode of the provider whose setting mode in the provider information table is set to the flexible settlement mode.

Specifically, the settlement mode setting unit 48 determines the settlement mode for each transaction provider based on the transaction amount which is specified by the settlement request and received by the settlement request reception unit 41 for each transaction provider or the advertisement price which is set by the advertisement price setting unit 47 for each transaction provider. The settlement mode information acquisition unit 44 sets the settlement mode determined for each transaction provider in the provider information table of the provider information storage unit 32.

The settlement mode setting unit 48, for example, determines the settlement mode for each transaction provider based on a settlement mode table stored in the provider information storage unit 32. FIG. 7 is a diagram illustrating an example of the settlement mode table stored in the provider information storage unit 32.

As illustrated in FIG. 7, the settlement mode table includes information associated with the “settlement mode of change destination”, the “total amount of transaction”, and the “total amount of appropriation advertisement prices”.

The “settlement mode of change destination” is information indicating a change in the settlement mode such as a “change to second settlement mode” and a “change to first settlement mode”. The “total amount of transaction” and the “total amount of appropriation advertisement prices” is the same information as those of the “total amount of transaction” and the “total amount of appropriation advertisement prices” illustrated in FIG. 6.

For example, it is assumed that the settlement mode table is in the state illustrated in FIG. 7 and the transaction provider received by the settlement request reception unit 41 is set to the first settlement mode. In this case, when the total amount of transaction of the transaction provider is equal to or more than 20 million yen or the total amount of appropriation advertisement prices of the transaction provider is equal to or more than 600,000 yen, the settlement mode information acquisition unit 44 changes the settlement mode of the transaction provider into the second settlement mode in the settlement mode table.

Further, for example, it is assumed that the settlement mode table is in the state illustrated in FIG. 7 and the transaction provider received by the settlement request reception unit 41 is set to the second settlement mode. In this case, when the total amount of transaction of the transaction provider is less than 15 million yen and the total amount of appropriation advertisement prices of the transaction provider is less than 450,000 yen, the settlement mode information acquisition unit 44 changes the settlement mode of the transaction provider into the first settlement mode in the settlement mode table.

In addition, the settlement mode setting unit 48 may change the settlement mode of the transaction provider with reference to one of the total amount of transaction and the total amount of appropriation advertisement prices, for example, based on a selection of the transaction provider or a setting of the settlement agency provider.

Further, the settlement mode setting unit 48 may set the settlement mode of the provider according to a total amount of the settlement agency fees for each transaction provider in a predetermined period of time (for example, a weekly or monthly period) instead of the total amount of transaction and the appropriation advertisement total amount. The settlement mode setting unit 48, for example, can set the settlement mode of the transaction provider whose total amount of the settlement agency fees is equal to or less than a predetermined amount to the first settlement mode, and can set the settlement mode of the transaction provider whose total amount of the settlement agency fees exceeds the predetermined amount to the second settlement mode.

4. Advertisement Delivery Apparatus 3

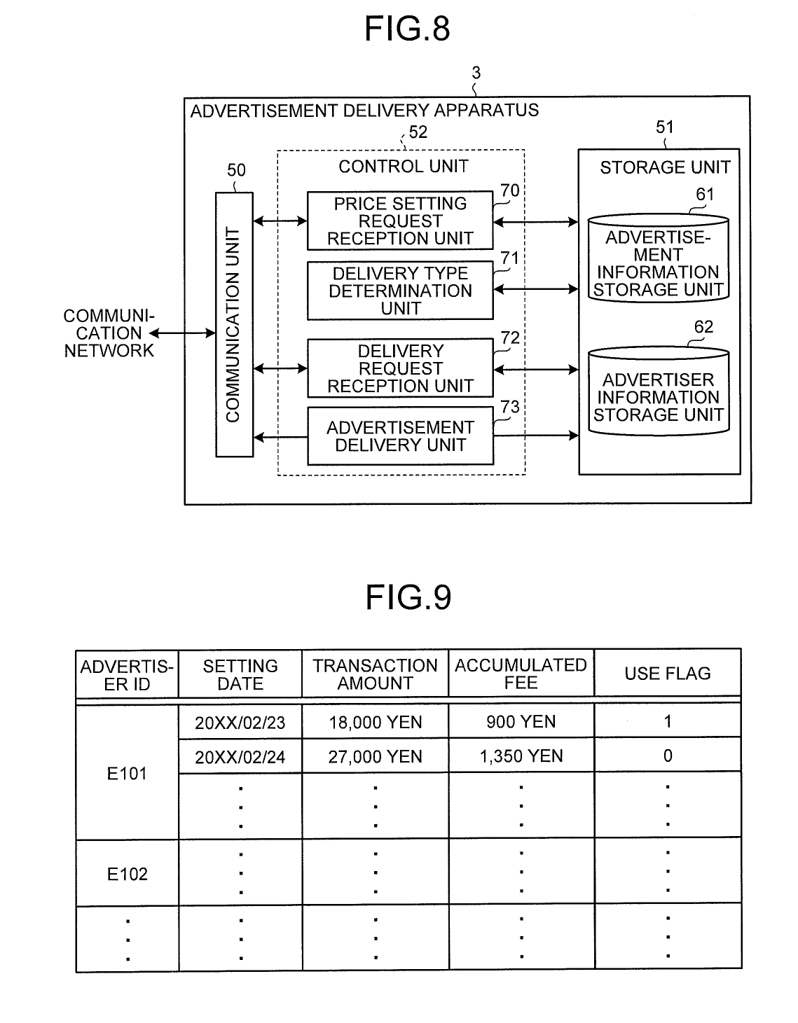

FIG. 8 is a diagram illustrating an exemplary configuration of the advertisement delivery apparatus 3 according to the embodiment. As illustrated in FIG. 8, the advertisement delivery apparatus 3 includes a communication unit 50, the storage unit 51, and a control unit 52.

The communication unit 50 is a communication interface to make communication between the apparatuses connected to the communication network 9 and the control unit 52. For example, the communication is performed through a protocol such as TCP/IP or UDP. The control unit 52 makes communication with the apparatuses connected to the communication network 9 through the communication unit 50.

The control unit 52, for example, is realized by an integrated circuit such as an ASIC or an FPGA. Further, for example, a program stored in the storage unit 51 is executed by a CPU or an MPU using internal RAM (not illustrated) as a work area, and thus the control unit 52 realizes or executes the following function and operation to process information.

Specifically, the control unit 52 executes an advertisement delivery program stored in the storage unit 51 to perform functions as a price setting request reception unit 70, a delivery type determination unit 71, the delivery request reception unit 72, and the advertisement delivery unit 73. In addition, the configuration of the control unit 52 is not limited the above configuration, and other configurations may be allowed as long as the information process described below is performed.

Further, the storage unit 51 includes an advertisement information storage unit 61 and an advertiser information storage unit 62. Hereinafter, the price setting request reception unit 70, the delivery type determination unit 71, the delivery request reception unit 72, and the advertisement delivery unit 73 will be specifically described while describing the advertisement information storage unit 61 and the advertiser information storage unit 62.

4.1. Price setting request reception unit 70

The price setting request reception unit 70 receives the advertisement price setting request transmitted from the settlement processing apparatus 2 to the advertisement delivery apparatus 3 through the communication network 9. When receiving the advertisement price setting request, the price setting request reception unit 70 updates an advertiser information table stored in the advertiser information storage unit 62 based on the information contained in the advertisement price setting request. As described above, the advertisement price setting request contains the information of the advertisement price, the information of the transaction amount, and the information of the transaction provider.

FIG. 9 is a diagram illustrating an example of the advertiser information table stored in the advertiser information storage unit 62. As illustrated in FIG. 9, the advertiser information table includes information associated with a “setting date”, a “transaction amount”, an “accumulated fee”, and a “use flag” for each “advertiser ID”.

The “advertiser ID” is identification information allocated to each advertiser, and in a case where the advertiser is the transaction provider, the provider ID (see FIG. 5) is set as an advertiser ID. In addition, in the embodiment, the advertiser ID and the provider ID of the same transaction provider are described as the same information, but the advertiser ID and the provider ID of the same transaction provider may be different information.

The “setting date”, for example, indicates a date when the information contained the advertisement price setting request is set in the advertiser information table. In the “transaction amount”, the information of the transaction amount contained in the advertisement price setting request is set. In the “accumulated fee”, the information of the advertisement price contained in the advertisement price setting request is set as an accumulated fee.

The “use flag” indicates whether the accumulated fee is used as a cost (advertisement price) of the advertisement delivery of the advertisement delivery apparatus 3. In a case where the “use flag” is set to “1”, it indicates that the accumulated fee is used at a cost of the advertisement delivery, and in a case where the “use flag” is set to “0”, it indicates that the accumulated fee is not used at a cost of the advertisement delivery.

For example, in a case where the advertiser information table is in the state illustrated in FIG. 9, the accumulated fee “3,600 yen” set at Feb. 23, 20XX is used at a cost of the advertisement delivery, and the accumulated fee “5,400 yen” set at Feb. 24, 20XX is not used at a cost of the advertisement delivery.

The price setting request reception unit 70 is the advertisement price set as the accumulated fee in the advertiser information table, and in a case where the advertisement price having the “use flag” of “0” is not used during a predetermined period of time after the setting, the “use flag” of a part or all of the advertisement prices not used during the predetermined period of time can be set to “1”. Therefore, the advertisement price not used during the predetermined period of time after being set as the advertisement price can be decreased or cancelled.

4.2. Delivery Type Determination Unit 71

The delivery type determination unit 71 determines a type of the advertisement information of which the delivery from the advertisement delivery unit 73 is allowed for each transaction provider based on the information of the accumulated fee (the advertisement price) set for each transaction provider and the information of the transaction amount.

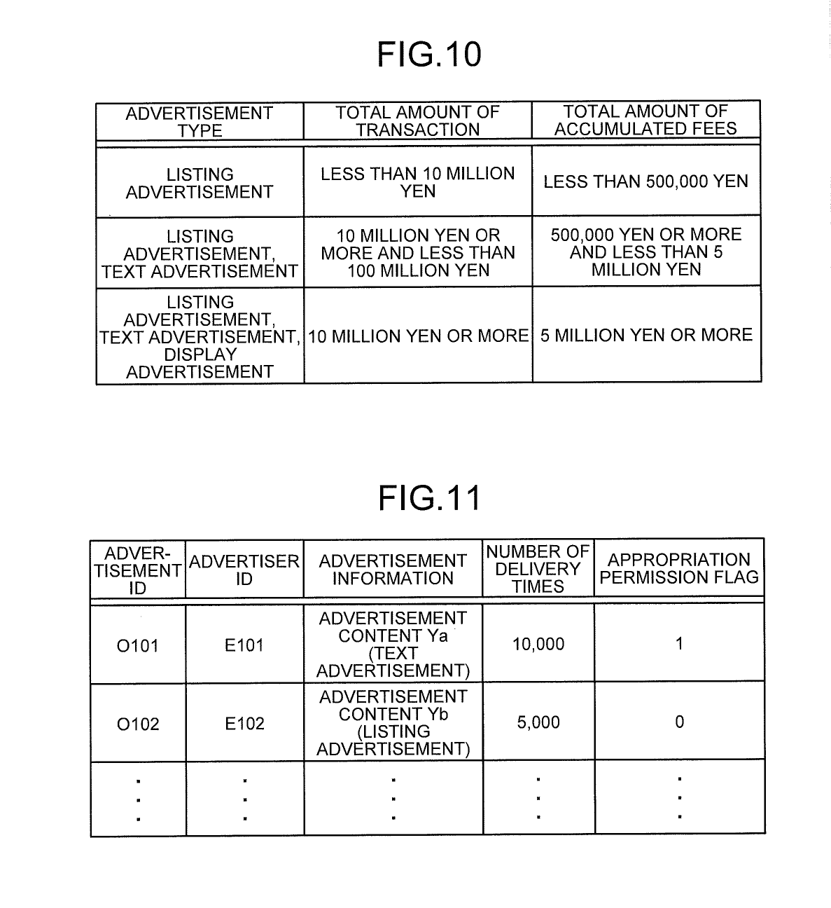

The delivery type determination unit 71, for example, determines the type of the advertisement information for each transaction provider based on a delivery type information table stored in the storage unit 51. FIG. 10 is a diagram illustrating an example of the delivery type information table stored in the storage unit 51.

As illustrated in FIG. 10, the delivery type information table includes information associated with an “advertisement type”, a “total amount of transaction”, and a “total amount of appropriation advertisement prices”. In a case where the accumulated fee is used as a cost of the advertisement delivery, the “advertisement type” is a type which can be selected by the transaction provider who is the advertiser.

The type of the advertisement includes a listing advertisement, a text advertisement, and a display advertisement. The listing advertisement is an advertisement to post search results of a search engine in a search result page. The text advertisement is an advertisement to display a text in a predetermined area of a web page. The display advertisement is an advertisement to display an image or a moving image clip in a predetermined area of a web page (for example, a banner advertisement).

The “total amount of transaction” is the same information as the “total amount of transaction” of the settlement agency fee table, and for example, indicates a total sum of the transaction amounts for each transaction provider set in the settlement agency fee table during a predetermined period of time. Further, a “total amount of accumulated fees” is the same information as the “total amount of appropriation advertisement prices” of the settlement agency fee table, and indicates a total sum of the accumulated fees for each transaction provider set in the settlement agency fee table during a predetermined period of time.

The delivery type determination unit 71 determines a type of the advertisement information of which the delivery from the advertisement delivery unit 73 is allowed for each transaction provider based on the “total amount of transaction” or the “total amount of accumulated fees”. In order to determine the type of the advertisement information, the information indicating which one of the “total amount of transaction” and the “total amount of accumulated fees” is used is set in the storage unit 51 for each transaction provider based on a selection of the transaction provider or a setting of the settlement agency provider. The delivery type determination unit 71 determines one of the “total amount of transaction” and the “total amount of accumulated fees” to be used based on the information stored in the storage unit 51.

For example, it is assumed that the delivery type information table is in the state illustrated in FIG. 10 and the “total amount of transaction” is set as the information to be used. In this case, the delivery type determination unit 71 allows the listing advertisement for the transaction provider whose total amount of transaction is less than 10 million yen, allows the listing advertisement and the text advertisement for the transaction provider whose total amount of transaction is equal to more than 10 million yen and less than 100 million yen, and allows the listing advertisement, the text advertisement, and the display advertisement for the transaction provider whose total amount of transaction is equal to or more 100 million yen.

Further, it is assumed that the delivery type information table is in the state illustrated in FIG. 10 and the “total amount of accumulated fees” is set as the information to be used. In this case, the delivery type determination unit 71 allows the listing advertisement the transaction provider whose total amount of the accumulated fees is less than 500,000 yen, allows the listing advertisement and the text advertisement for the transaction provider whose total amount of the accumulated fees is equal to or more than 500,000 yen and less than 5 million yen, and allows the listing advertisement, the text advertisement, and the display advertisement for the transaction provider whose total amount of the accumulated fees is equal to or more than 5 million yen.

In addition, the delivery type determination unit 71 may determine the type of the advertisement information of which the delivery from the advertisement delivery unit 73 is allowed for each transaction provider based on a combination of the “total amount of transaction” and the “total amount of accumulated fees”.

4.3. Delivery Request Reception Unit 72

The delivery request reception unit 72, for example, receives the advertisement delivery request transmitted from the terminal apparatus of the transaction provider to the advertisement delivery apparatus 3 through the communication network 9. The advertisement delivery request, for example, contains information for specifying the transaction provider, the advertisement information, the information of the advertisement delivery condition, and information indicating whether the accumulated fee is available.

When receiving the advertisement delivery request, the delivery request reception unit 72 sets the information contained in the advertisement delivery request in an advertisement information table stored in the advertisement information storage unit 61. FIG. 11 is a diagram illustrating an example of the advertisement information table stored in the advertisement information storage unit 61.

As illustrated in FIG. 11, the advertisement information table includes information associated with an “advertiser ID”, an “advertisement information”, a “number of delivery times”, and an “appropriation permission flag” for each “advertisement ID”. The “advertisement ID” is identification information to be allocated for each advertisement delivery request by the delivery request reception unit 72.

The “advertiser ID” is identification information of the advertiser who requests the advertisement delivery. In a case where the advertiser who requests the advertisement delivery is the transaction provider, the provider ID (see FIG. 5) is set as an advertiser ID.

The “advertisement information” is advertisement information of the delivery target, and for example, contains advertisement content such as text, still image information, moving image information, and banner information, and information for specifying an advertisement type. In addition, the advertisement content contains image elements for displaying the advertisement and program codes, and link information for acquiring these image elements and program codes.

The “number of delivery times” is the number of times to post the advertisement information designated by the advertisement delivery request in the advertising medium. The advertising medium, for example, includes a web site, an e-mail, and a digital signage. For example, in a case where the advertising medium is the web page, the “number of delivery times” is the number of delivery times to the terminal apparatus of the web page. In addition, only the number of delivery times is set as the advertisement delivery condition in the advertisement information table illustrated in FIG. 11, but information of the delivery period, attribute information of a user at a delivery destination, and a type of a delivery advertisement can also be set.

The “appropriation permission flag” indicates whether the accumulated fee is available. In a case where the “appropriation permission flag” is set to “1”, it indicates that the accumulated fee is used as a cost of the delivery of the advertisement information. In a case where the “appropriation permission flag” is set to “0”, it indicates that the accumulated fee is not used as a cost of the delivery of the advertisement information.

4.4. Advertisement Delivery Unit 73

The advertisement delivery unit 73 performs a delivery process of delivering the advertisement information designated by the advertiser to the advertising medium under the delivery condition designated by the advertiser based on the information set in the advertisement information table, under the delivery condition designated by the advertiser.

In a case where the advertisement information designated by the advertisement delivery request containing the information indicating that the accumulated fee is available is delivered, the advertisement delivery unit 73 uses the accumulated fee as a cost of the delivery of the advertisement information contained in the advertisement delivery request.

Specifically, the advertisement delivery unit 73 determines the advertisement delivery fee based on the delivery condition contained in the advertisement delivery request, and determines whether the accumulated fee corresponding to the advertisement delivery fee is set in the advertiser information table.

For example, it is assumed that the transaction provider specified by the advertisement delivery request is the advertiser of the provider ID “E101”, the advertisement delivery fee determined based on the delivery condition is “50,000 yen”, and the advertiser information table is in the state illustrated in FIG. 9. In this case, when the accumulated fee of which the “use flag” is set to “0” is added up to “50,000 yen”, the advertisement delivery unit 73 determines that the accumulated fee corresponding to the advertisement delivery fee is set in the advertiser information table, and sets the “use flag” corresponding to the accumulated fee of an addition target to “1”.

On the other hand, in a case where the accumulated fee of which the “use flag” is set to “0” is not added up to “50,000 yen”, the advertisement delivery unit 73 determines that the accumulated fee corresponding to the advertisement delivery fee is not set in the advertiser information table, and for example, allocates an unused advertisement price deposited from the transaction provider as a cost of the delivery of the advertisement information.

In addition, even in a case where the accumulated fee corresponding to the advertisement delivery fee is not set in the advertiser information table, the advertisement delivery unit 73 may use some of the accumulated fee as a cost of the delivery of the advertisement information. Even in this case, the “use flag” of the accumulated fee used as a cost of the delivery of the advertisement information is set to “1”.

Further, for example, in a case where the “total amount of transaction” is equal to or more than a predetermined amount, or in a case where the “total amount of accumulated fees” is not equal to or more than the predetermined amount, the advertisement delivery unit 73, for example, the unused advertisement price deposited from the transaction provider is allocated as a cost of the delivery of the advertisement information.

Further, in a case where the type of the delivery advertisement designated by the advertisement delivery request does not satisfy the available type of the transaction provider determined by the delivery type determination unit 71, the advertisement delivery unit 73, for example, allocates the unused advertisement price deposited from the transaction provider as a cost of the delivery of the advertisement information.

Further, similarly even in a case where the information indicating that the accumulated fee is not available is contained in the advertisement delivery request, the advertisement delivery unit 73, for example, allocates the unused advertisement price deposited from the transaction provider as a cost of the delivery of the advertisement information. In addition, the advertisement delivery unit 73 may collectively charge the advertisement prices to the transaction provider who makes a predetermined contract in every predetermined period of time.

5. Process of Information Processing System 1

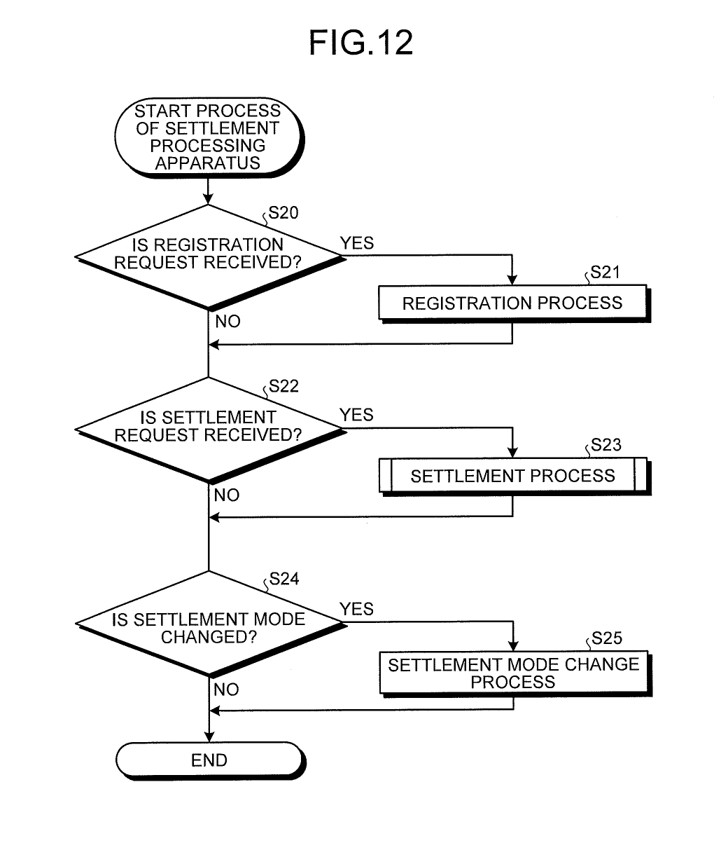

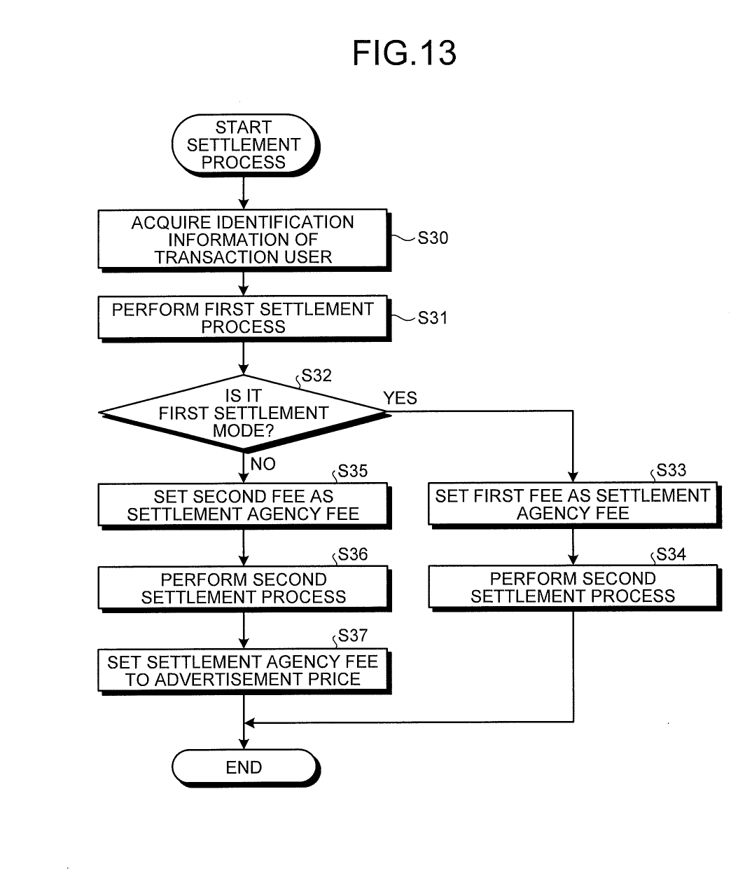

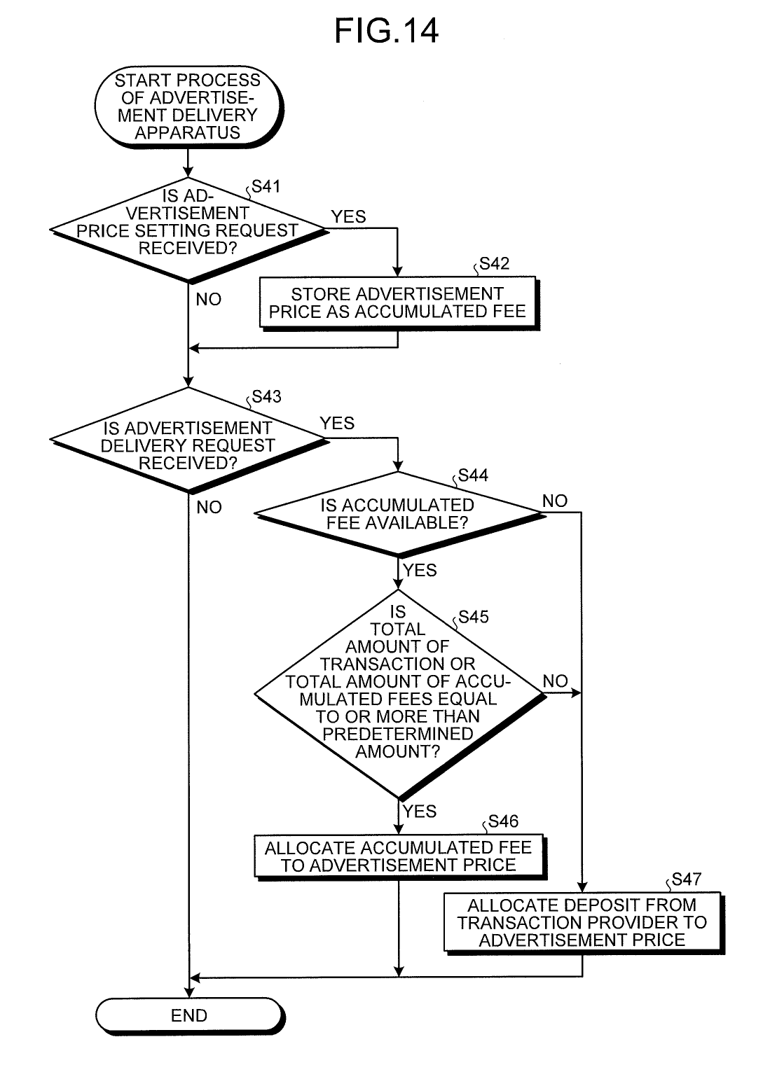

Next, a sequence of information processing performed by the information processing system 1 according to the embodiment will be described. FIGS. 12 to 14 are diagrams for describing an information processing flow in the information processing system 1. In the following, the information processing of the settlement processing apparatus 2 will be described with reference to FIGS. 12 and 13, and the information processing of the advertisement delivery apparatus 3 will be described with reference to FIG. 14.

5.1. Process of Settlement processing apparatus 2

First, the information processing of the settlement processing apparatus 2 according to the embodiment will be described. FIG. 12 is a flowchart illustrating an example of the information processing of the settlement processing apparatus 2 according to the embodiment. The corresponding operations are the processes repeatedly performed by the control unit 22 of the settlement processing apparatus 2.

As illustrated in FIG. 12, the control unit 22 of the settlement processing apparatus 2 determines whether a registration request is received (Step S20). The registration request, for example, is the user information registering request transmitted from the transaction user apparatus 6 or the provider information registration request transmitted from the transaction provider apparatus 7.

In a case where it is determined that the registration request is received (Yes in Step S20), the control unit 22 performs a registration process according to the registration request (Step S21). For example, in a case where the user information registering request is received, the control unit 22 changes the user information table of the user information storage unit 31 based on the information contained in the user information registering request. Further, in a case where the provider information registration request is received, the control unit 22 changes the provider information table of the provider information storage unit 32 based on the information contained in the provider information registration request.

In a case where the process of Step S21 is completed, or in a case where it is determined that the registration request is not received (No in Step S20), the control unit 22 determines whether the settlement request transmitted from the transaction user apparatus 6 or the transaction provider apparatus 7 is received (Step S22).

In a case where it is determined that the settlement request is received (Yes in Step S22), the control unit 22 performs a settlement process (Step S23). The settlement process, for example, corresponds to the processes of Steps S30 to S37 illustrated in FIG. 13 (to be described in detail below).

In a case where the process of Step S23 is completed, or in a case where it is determined that the settlement request is not received (No in Step S22), the control unit 22 determines whether the settlement mode is changed (Step S24). For example, in a case where it is determined that the settlement mode is changed based on the settlement mode table, or in a case where a request for changing the settlement mode is received from the terminal apparatus of the transaction provider, the control unit 22 determines that the settlement mode is changed.

In a case where it is determined that the settlement mode is changed (Yes in Step S24), the control unit 22 changes the settlement mode of the transaction provider on which it is determined that the settlement mode is changed (Step S25). In a case where the process of Step S25 is completed, or in a case where it is determined that the settlement mode is not changed (No in Step S24), the control unit 22 ends the process.

Next, the settlement process of Step S23 will be described. FIG. 13 is a flowchart illustrating an example of the settlement process of the settlement processing apparatus 2.

As illustrated in FIG. 13, the control unit 22 acquires the identification information of the transaction user contained in the settlement request (Step S30) and performs a first settlement process based on the identification information of the transaction user (Step S31). The first settlement process is a process in which an amount obtained by deducting a predetermined handling fee from the transaction amount specified by the settlement request as a deposit amount from the financial institution.

Next, the control unit 22 determines whether the settlement mode of the transaction provider contained in the settlement request is the first settlement mode (Step S32). In a case where the settlement mode of the transaction provider is the first settlement mode (Yes in Step S32), the control unit 22 sets the first fee as the settlement agency fee (Step S33) and performs a second settlement process (Step S34). In the second settlement process, the control unit 22 performs a settlement process in which an amount obtained by deducting the settlement agency fee (the first fee) from the transaction amount specified by the settlement request as a remittance to the transaction provider.

On the other hand, in a case where the settlement mode of the transaction provider is not the first settlement mode but the second settlement mode (No in Step S32), the control unit 22 sets the second fee as the settlement agency fee (Step S35) and performs the second settlement process similarly to Step S34 (Step S36). In a case where the process of Step S36 is completed, the control unit 22 sets the settlement agency fee (the second fee) as the advertisement price and transmits the advertisement price setting request to the advertisement delivery apparatus 3 (Step S37). When the processes of Steps S34 and S37 are ended, the control unit 22 ends the settlement process.

5.2. Process of Advertisement Delivery Apparatus 3

Next, the information processing of the advertisement delivery apparatus 3 according to the embodiment will be described. FIG. 14 is a flowchart illustrating an example of the information processing of the advertisement delivery apparatus 3 according to the embodiment. The corresponding operations are the processes repeatedly performed by the control unit 52 of the advertisement delivery apparatus 3.

As illustrated in FIG. 14, the control unit 52 of the advertisement delivery apparatus 3 determines whether the advertisement price setting request transmitted from the settlement processing apparatus 2 is received (Step S41). In a case where it is determined that the advertisement price setting request is received (Yes in Step S41), the control unit 22 sets the advertisement price specified by the advertisement price setting request as the accumulated fee in an advertiser information table stored in the storage unit 51 (Step S42).

In a case where the process of Step S42 is completed, or in a case where it is determined that the advertisement price setting request is not received (No in Step S41), the control unit 22 determines whether the advertisement delivery request is received (Step S43).

In a case where it is determined that the advertisement delivery request is received (Yes in Step S43), the control unit 52 determines whether the accumulated fee is available (Step S44). In the corresponding operations, in a case where the information indicating that the accumulated fee is available is contained in the advertisement delivery request, the control unit 52 determines that the accumulated fee is available. In a case where the information indicating that the accumulated fee is not available is contained in the advertisement delivery request, the control unit 52 determines that the accumulated fee is not available.

In a case where it is determined that the accumulated fee is available (Yes in Step S44), the control unit 52 determines whether the total amount of transaction or the total amount of the accumulated fees is equal to or more than a predetermined amount (Step S45). In a case where it is determined that the total amount of transaction or the total amount of the accumulated fees is equal to or more than the predetermined amount (Yes in Step S45), the control unit 52 allocates the accumulated fee as a cost (the advertisement price) of the advertisement delivery (Step S46).

In a case where it is determined that the accumulated fee is not available (No in Step S44), or in a case where the total amount of transaction or the total amount of the accumulated fees is not equal to or more than the predetermined amount (No in Step S45), the control unit 52 performs a process of allocating the advertisement price deposited from the transaction provider as a cost of the advertisement delivery. In addition, the control unit 52 may collectively charge the advertisement prices to the transaction provider who makes a predetermined contract in every predetermined period of time.

In a case where the processes of Steps S46 and S47 are completed, or in a case where it is determined that the advertisement delivery request is not received (No in Step S43), the control unit 52 ends the process.

6. Modified Example

In the above-mentioned embodiment, the description has been made about that the settlement processing apparatus 2 has the first settlement mode and the second settlement mode. However, the settlement processing apparatus 2 may have only the second settlement mode.

Further, the description has been made about that in the case of the flexible settlement mode, when the total amount of transaction or the total amount of the accumulated fees is large, the settlement mode setting unit 48 selects the second settlement mode. However, in a case where the total amount of transaction or the total amount of the accumulated fees is small, the settlement mode setting unit 48 may select the second settlement mode. Further, in the case of the flexible settlement mode, when a variation rate of the total amount of transaction, the total amount of the accumulated fees, or the total amount of the settlement agency fees is large, the settlement mode setting unit 48 may select the second settlement mode.

Further, the description has been made about that in the case of the flexible settlement mode, when the total amount of transaction or the total amount of the accumulated fees is large, the second processing unit 46 decreases the settlement agency fee. However, in a case where the total amount of transaction or the total amount of the accumulated fees is small, the settlement agency fee may be decreased. In a case where a variation rate of the total amount of transaction or the total amount of the accumulated fees is large, the second processing unit 46 may decrease the settlement agency fee.

Further, the description has been made about that the delivery type determination unit 71 determines the type of the advertisement information for each transaction provider according to the total amount of transaction or the total amount of the accumulated fees. However, the type of advertisement information may be determined for each transaction provider according to a variation rate of the total amount of transaction or the total amount of the accumulated fees.

Further, the above-mentioned information processing system 1 has been described by classifying into the settlement processing apparatus 2 and the advertisement delivery apparatus 3. However, the settlement processing apparatus 2 and the advertisement delivery apparatus 3 may be configured into one server apparatus.

The advertisement price setting unit 47 may set some of the settlement agency fee as the advertisement price at a rate according to the total amount of transaction or the total amount of the accumulated fees. For example, as the total amount of transaction or the total amount of the accumulated fees increases, the advertisement price setting unit 47 may increase a rate of the settlement agency fee which is set as the advertisement price. On the contrary, as the total amount of transaction or the total amount of the accumulated fees is increased, a rate of the settlement agency fee which is set as the advertisement price may be decreased.

Further, in the above-mentioned embodiment, the settlement agency fee (the second fee) of the second settlement mode is set to be higher than the settlement agency fee (the first fee) of the first settlement mode. However, the settlement agency fee of the second settlement mode and the settlement agency fee of the first settlement mode may be set to be the same amount.

Further, in the above-mentioned embodiment, the information indicating whether the accumulated fee is available is contained in the advertisement delivery request, the information indicating whether the accumulated fee is available may not be contained in the advertisement delivery request. In this case, when there is the accumulated fee of which the “use flag” is set to “0”, the advertisement delivery unit 73 allocates the accumulated fee as a cost of the delivery of the advertisement information.

Further, in the above-mentioned embodiment, the description has been made by classifying into the unused advertisement price deposited from the transaction provider and the accumulated fee. However, the advertisement delivery unit 73 may allocate a cost of the delivery of the advertisement information from an amount obtained by adding an unused accumulated fee to the unused advertisement price deposited from the transaction provider.

7. Hardware Configuration

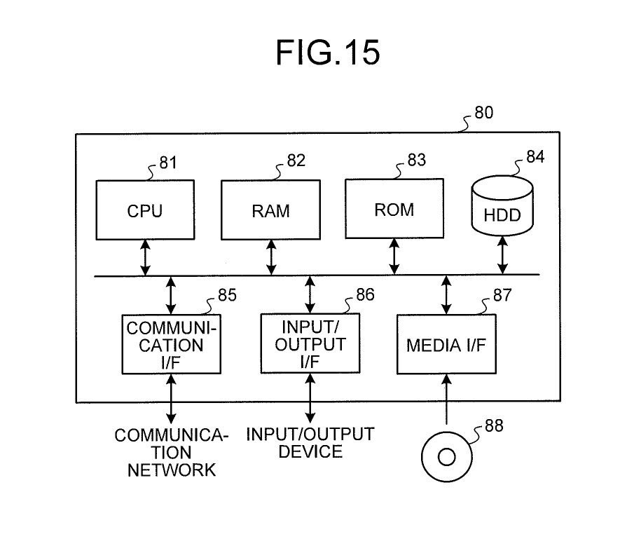

In addition, the settlement processing apparatus 2 and the advertisement delivery apparatus 3 in the embodiment, for example, are realized by a computer 80 configured as illustrated in FIG. 15. FIG. 15 is a diagram illustrating an example of a hardware configuration of the computer which realizes functions of the settlement processing apparatus 2 and the advertisement delivery apparatus 3. The computer 80 includes a central processing unit (CPU) 81, random access memory (RAM) 82, read only memory (ROM) 83, a hard disk drive (HDD) 84, a communication interface (I/F) 85, an input/output interface (I/F) 86, and a media interface (I/F) 87.

The CPU 81 operates based on a program stored in the ROM 83 or the HDD 84 and controls the respective parts. The ROM 83 stores a boot program which is executed by the CPU 81 when the computer 80 is powered up and a program dependent on the hardware of the computer 80.

The HDD 84 stores a program which is executed by the CPU 81 and data which is used by the program. The communication interface 85 corresponds to the communication unit 20 or the communication unit 50, receives data from other apparatuses through the communication network 9 and transmits the data to the CPU 81, and transmits data generated by the CPU 81 to the other apparatuses through the communication network 9.

The CPU 81 controls an output device such as a display and a printer, and an input device such as a keyboard and a mouse through the input/output interface 86. The CPU 81 acquires data from the input device through the input/output interface 86. Further, the CPU 81 outputs the generated data to the output device through the input/output interface 86.

The media interface 87 reads a program or data stored in a recording medium 88 and provides the program or the data to the CPU 81 through the RAM 82. The CPU 81 loads the program from the recording medium 88 onto the RAM 82 through the media interface 87 and executes the loaded program. The recording medium 88, for example, includes an optical recording medium such as a digital versatile disc (DVD) and a phase change rewritable disk (PD), a magneto-optical recording medium such as a magneto-optical disk (MO), a tape medium, a magnetic recording medium, or semiconductor memory.

In a case where the computer 80 functions as the settlement processing apparatus 2, the CPU 81 of the computer 80 executes the program loaded onto the RAM 82 to realize the respective functions of the registration request reception unit 40, the settlement request reception unit 41, the user information acquisition unit 42, the first processing unit 43, the settlement mode information acquisition unit 44, the fee setting unit 45, the second processing unit 46, the advertisement price setting unit 47, and the settlement mode setting unit 48. Further, the HDD 84 realizes the function of the storage unit 21 and stores the user information table, the provider information table, the settlement agency fee table, and the settlement mode table.

Further, in a case where the computer 80 functions as the advertisement delivery apparatus 3, the CPU 81 of the computer 80 executes the program loaded onto the RAM 82 to realize the respective functions of the price setting request reception unit 70, the delivery type determination unit 71, the delivery request reception unit 72, and the advertisement delivery unit 73. Further, the HDD 84 realizes the function of the storage unit 51 and stores the advertisement information table, the provider information table, and the delivery type information table.

The CPU 81 of the computer 80 reads these programs out of the recording medium 88 for execution. However, as another example, the programs may be acquired from another apparatus through the communication network 9.

8. Advantages

The settlement processing apparatus 2 according to the embodiment includes the user information storage unit 31 (an example of a user information storage unit), the settlement request reception unit 41, the user information acquisition unit 42 (an example of an acquisition unit), the first processing unit 43, the second processing unit 46, and the advertisement price setting unit 47 (an example of an advertisement price setting unit). The user information storage unit 31 stores the information for specifying the transaction user and the identification information of the transaction user in the financial institution in association with each other. The settlement request reception unit 41 receives the settlement request which contains the information for specifying the transaction user, the transaction amount, and the transaction provider. The user information acquisition unit 42 acquires the identification information of the transaction user specified by the settlement request received in the settlement request reception unit 41 from the user information storage unit 31. The first processing unit 43 performs a settlement process based on the identification information of the transaction user acquired by the user information acquisition unit 42, in which an amount obtained by deducting the handling fee of the financial institution from the transaction amount specified by the settlement request is set as a deposit amount from the financial institution. The second processing unit 46 performs the settlement process in which an amount obtained by deducting the settlement agency fee including the handling fee of the financial institution from the transaction amount specified by the settlement request is set as the remittance to the transaction provider. The advertisement price setting unit 47 sets a part or all of the settlement agency fees as the advertisement price of the transaction provider in the advertisement delivery of the advertisement delivery apparatus 3.

In this way, since the settlement processing apparatus 2 sets a part or all of the settlement agency fees as the advertisement price of the transaction provider, the transaction provider can use the settlement agency fee only for the payment in the related art as the advertisement price. Therefore, it is possible to promote the use of the settlement agency service which is performed by the settlement agent. Furthermore, it is possible to promote the use of the advertisement delivery.

Further, the settlement processing apparatus 2 includes the provider information storage unit 32 (an example of a provider storage unit), the settlement mode information acquisition unit 44, and the fee setting unit 45. The provider information storage unit 32 stores the information of the transaction provider and the information of the settlement mode in association with each other. The settlement mode information acquisition unit 44 acquires the information of the settlement mode associated with the information of the transaction provider specified by the settlement request from the provider information storage unit 32. In a case where the information of the settlement mode acquired by the settlement mode information acquisition unit 44 is the information of the first settlement mode, the fee setting unit 45 sets the settlement agency fee to the first fee. In a case where the information of the settlement mode acquired by the settlement mode information acquisition unit 44 is the information of the second settlement mode, the fee setting unit 45 sets the settlement agency fee to the second fee. In a case where the settlement agency fee is set to the second fee by the fee setting unit 45, the advertisement price setting unit 47 sets a part or all of the settlement agency fees as the advertisement price of the transaction provider.

In this way, in the settlement processing apparatus 2, the transaction provider is handled in any one of the first settlement mode and the second settlement mode. In a case where the transaction provider is set to the first settlement mode, the settlement agency fee is not set to the advertisement price. However, in a case where the transaction provider is set to the second settlement mode, the settlement agency fee is set to the advertisement price. Therefore, it is possible to provide an attractive settlement agency service to the transaction provider. For example, the transaction provider can select whether the settlement agency fee is set to the advertisement price by allowing the transaction provider to select the settlement mode. Further, by setting the second fee higher than the first fee, the settlement agent can obtain a cost of all the services which include the settlement agency process by the advertisement price and the delivery process.

Further, the settlement processing apparatus 2 includes the settlement mode setting unit 48. The settlement mode setting unit 48 sets the settlement mode for each transaction provider to the provider information storage unit 32 in association with the information of the transaction provider based on the transaction amount received by the settlement request reception unit 41 for each transaction provider, the advertisement price set by the advertisement price setting unit 47 for each transaction provider, or the settlement agency fee for each transaction provider.

With this configuration, since the settlement processing apparatus 2 sets the settlement mode according to the transaction amount of the transaction provider or the accumulated fee of the transaction provider, it is possible to dynamically change the settlement mode of the transaction provider. Therefore, for example, the transaction provider is motivated to frequently use the settlement agency service by selecting the second settlement mode for the transaction provider whose total amount of transaction or total amount of the accumulated fees is large. Therefore, it is possible to promote the use of the settlement agency service, and accordingly the use of the advertisement delivery service can be promoted.

Further, the settlement processing apparatus 2 includes the fee setting unit 45. The fee setting unit 45 changes the settlement agency fee for each transaction provider based on the transaction amount received by the settlement request reception unit 41 for each transaction provider or the advertisement price set by the advertisement price setting unit 47 for each transaction provider.

In this way, the settlement processing apparatus 2 changes the settlement agency fee according to the transaction amount of the transaction provider or the accumulated fee of the transaction provider. Therefore, for example, the transaction provider is motivated to frequently use the settlement agency service by reducing the settlement agency fee as the total amount of transaction or the total amount of the accumulated fees is increased. Further, it is possible to promote the use of the settlement agency service, and accordingly the user of the advertisement delivery service can be motivated.

The price setting request reception unit 70 (an example of the advertisement price setting unit) can decrease or cancel the advertisement price not used during the predetermined period of time after being set as the advertisement price.

Therefore, since the transaction provider can be urged to make the advertisement delivery request in a predetermined period of time, the user of the advertisement delivery service can be further promoted.

Further, the information processing system 1 according to the embodiment includes the settlement processing apparatus 2 and the advertisement delivery apparatus 3. The advertisement delivery apparatus 3 includes the advertiser information storage unit 62 (an example of a price information storage unit), the delivery request reception unit 72, and the advertisement delivery unit 73. The advertiser information storage unit 62 stores the information of the advertisement price set by the advertisement price setting unit 47. The delivery request reception unit 72 receives a delivery request containing the advertisement information of the transaction provider. The advertisement delivery unit 73 delivers the advertisement information contained in the delivery request based on the information of the advertisement price stored in the advertiser information storage unit 62.

Therefore, it is possible to provide the information processing system 1 including the advertisement delivery apparatus 3 in addition to the settlement processing apparatus 2.

Further, the delivery request contains information indicating whether the advertisement price is available. In a case where the information indicating whether the advertisement price is available is contained in the delivery request, the advertisement delivery unit 73 delivers the advertisement information contained in the delivery request based on the information of the advertisement price stored in the advertiser information storage unit 62.

Therefore, since the transaction provider can use the accumulated fee at an arbitrary timing point, for example, the accumulated fee can be used according to a procurement situation of a fund reserved for the advertisement delivery, and the convenience of the transaction provider can be improved.

The delivery type determination unit 71 determines the type of the advertisement information of which the delivery from the advertisement delivery unit 73 is allowed based on the transaction amount received by the settlement request reception unit 41 for each transaction provider or the advertisement price set by the advertisement price setting unit 47 for each transaction provider.

Therefore, for example, the transaction provider is motivated to further frequently use the settlement agency service by increasing the number of types of the delivering advertisement as the transaction amount or the accumulated fee is increased. Thus, it is possible to promote the use of the settlement agency service, and accordingly the use of the advertisement delivery service can be promoted.

In a case where it is determined that the total amount of the advertisement prices of the transaction provider is equal to or more than a predetermined amount based on the information of the advertisement price, the advertisement delivery unit 73 appropriates a cost of the delivery of the advertisement information of the transaction provider from the advertisement price.

With this configuration, only in a case where the total amount of the accumulated fees set for transaction provider is equal to or more than the predetermined amount, the accumulated fee is available. Therefore, it is possible to prevent that the process of allocating the accumulated fee by the advertisement delivery apparatus 3 becomes complicated.

9. Others

The settlement processing apparatus 2 and the advertisement delivery apparatus 3 described above each may be realized by a plurality of server computers or by calling an application programming interface (API) such as an external platform or a network computing according to the functions. Therefore, the configuration can be flexibly changed.

Further, since the arrows depicted in FIG. 1 and the like are used to accessorily illustrate the flow of data or control, it is not intended to exclude other flows or limit the directions thereto. Further, the ID information listed in FIGS. 4, 5, 9, and 11 is information attached to help with understanding, but the invention is not limited to the information listed in these drawings.

According to the embodiment, it is possible to provide a settlement processing apparatus, an information processing system, a settlement processing program, and a settlement processing method which can promote the use of an advertisement delivery service.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A settlement processing apparatus comprising:
a user information storage unit configured to store information for specifying a transaction user and identification information of the transaction user in a financial institution in association with each other;
a settlement request reception unit configured to receive a settlement request containing information for specifying the transaction user, a transaction amount, and a transaction provider;
an acquisition unit configured to acquire the identification information of the transaction user specified by the settlement request received by the settlement request reception unit from the user information storage unit;
a first processing unit configured to perform a settlement process of setting an amount obtained by deducting a fee of the financial institution from the transaction amount specified by the settlement request as a deposit amount from the financial institution based on the identification information of the transaction user acquired by the acquisition unit;
a second processing unit configured to perform a settlement process of setting an amount obtained by deducting a settlement agency fee including a fee of the financial institution from the transaction amount specified by the settlement request as a remittance to the transaction provider; and
an advertisement price setting unit configured to set a part or all of the settlement agency fees as an advertisement price of the transaction provider in advertisement delivery of an advertisement delivery apparatus.

2. The settlement processing apparatus according to claim 1, further comprising:
a provider storage unit configured to store information of the transaction provider and information of a settlement mode in association with each other;
a settlement mode information acquisition unit configured to acquire the information of the settlement mode associated with the information of the transaction provider specified by the settlement request from the provider storage unit; and
a fee setting unit configured to set the settlement agency fee to a first fee when the information of the settlement mode acquired by the settlement mode information acquisition unit is information of a first settlement mode, and to set the settlement agency fee to a second fee when the information of the settlement mode acquired by the settlement mode information acquisition unit is information of a second settlement mode,
wherein the advertisement price setting unit sets a part or all of the settlement agency fees as the advertisement price of the transaction provider when the settlement agency fee is set to the second fee by the fee setting unit.

3. The settlement processing apparatus according to claim 2, further comprising:
a settlement mode setting unit configured to set the settlement mode for each transaction provider to the provider storage unit in association with the information of the transaction provider based on the transaction amount for each transaction provider which is received by the settlement request reception unit, the advertisement price for each transaction provider which is set by the advertisement price setting unit, or the settlement agency fee for each transaction provider.

4. The settlement processing apparatus according to claim 1, further comprising:
a fee setting unit configured to change the settlement agency fee for each transaction provider based on the transaction amount for each transaction provider which is received by the settlement request reception unit or the advertisement price for transaction provider which is set by the advertisement price setting unit.

5. The settlement processing apparatus according to claim 1, wherein
the advertisement price setting unit decreases or cancels the advertisement price which is not used for a predetermined period of time after being set as the advertisement price.

6. An information processing system comprising:
the settlement processing apparatus according to claim 1; and
the advertisement delivery apparatus configured to perform a delivery process of advertisement information,
wherein the advertisement delivery apparatus includes
a price information storage unit configured to store information of the advertisement price set by the advertisement price setting unit,
a delivery request reception unit configured to receive a delivery request containing the advertisement information, and
an advertisement delivery unit configured to deliver the advertisement information contained in the delivery request based on the information of the advertisement price which is stored in the price information storage unit.

7. The information processing system according to claim 6, further comprising:
a determination unit configured to determine a type of the advertisement information of which the delivery from the advertisement delivery unit is allowed based on the transaction amount for each transaction provider which is received by the settlement request reception unit or the advertisement price which is set for each transaction provider by the advertisement price setting unit.

8. The information processing system according to claim 6, wherein
the advertisement delivery unit appropriates a cost of a delivery of the advertisement information of the transaction provider from the advertisement price when it is determined that a total amount of the advertisement prices set for the transaction provider is equal to or more than a predetermined amount based on the information of the advertisement price.

9. A non-transitory computer readable storage medium containing program instructions for processing a settlement, wherein execution of the program instructions by one or more processors of a computer system causes the one or more processors to perform:
receiving a settlement request containing information for specifying a transaction user, a transaction amount, and a transaction provider;
acquiring identification information of the transaction user specified by the settlement request from a user information storage unit which stores information specified by the transaction user and the identification information of the transaction user in association with each other;
performing a settlement process of setting an amount obtained by deducting a fee of the financial institution from the transaction amount specified by the settlement request as a deposit amount from the financial institution based on the identification information of the transaction user acquired in the acquiring;
performing a settlement process of setting an amount obtained by deducting a settlement agency fee including a fee of the financial institution from the transaction amount specified by the settlement request as a remittance to the transaction provider; and
setting a part or all of the settlement agency fees as an advertisement price of the transaction provider in advertisement delivery of an advertisement delivery apparatus.

10. A settlement processing method which is performed by a computer, comprising:
receiving a settlement request which contains information for specifying a transaction user, a transaction amount, and a transaction provider is received;
acquiring identification information of the transaction user specified by the settlement request from a user information storage unit which stores information specified by the transaction user and the identification information of the transaction user in association with each other;
performing a settlement process of setting an amount obtained by deducting a fee of the financial institution from the transaction amount specified by the settlement request as a deposit amount from the financial institution based on the identification information of the transaction user acquired in the acquiring;
performing a settlement process of setting an amount obtained by deducting a settlement agency fee including a fee of the financial institution from the transaction amount specified by the settlement request as a remittance to the transaction provider; and
setting a part or all of the settlement agency fees as an advertisement price of the transaction provider in advertisement delivery of an advertisement delivery apparatus.
